(19) United States
(12) Patent Application Publication
(10) Pub. No.: US 2022/0144088 A1
(43) Pub. Date: May 12, 2022

(54) DISPLAY DEVICE CONTROL APPARATUS

(71) Applicant: DENSO CORPORATION, Kariya-city (JP)

(72) Inventors: Satoru TANAKA, Kariya-city (JP); Kiyotaka TAGUCHI, Kariya-city (JP); Masato UTSUNOMIYA, Kariya-city (JP)

(21) Appl. No.: 17/580,139

(22) Filed: Jan. 20, 2022

Related U.S. Application Data
(63) Continuation of application No. PCT/JP2020/027663, filed on Jul. 16, 2020.

(30) Foreign Application Priority Data
Jul. 25, 2019 (JP) 2019-136867
Oct. 2, 2019 (JP) 2019-182101

(51) Int. Cl. B60K 35/00

(52) U.S. Cl. CPC B60K 35/00; B60K 2370/52; B60K 2370/1876; B60Y 2300/095; B60K 2370/193; B60K 2370/149; B60K 2370/349; B60K 2370/178

(57) ABSTRACT

A display device control apparatus is provided to control a display device provided on an instrument panel of a vehicle. The display device control apparatus acquires a state of the vehicle, and sets an inclination of a display screen unit included in the display device according to the state of the vehicle.

### CROSS REFERENCE TO RELATED APPLICATIONS

The present application is a continuation application of International Patent Application No. PCT/JP2020/027663 filed on Jul. 16, 2020, which designated the U.S. and claims the benefit of priority from Japanese Patent Application No. 2019-136867 filed on Jul. 25, 2019, and Japanese Patent Application No. 2019-182101 filed on Oct. 2, 2019. The entire disclosures of all of the above applications are incorporated herein by reference.

### TECHNICAL FIELD

The present disclosure relates to a display device control apparatus.

### BACKGROUND

There is disclosed an in-vehicle display apparatus that includes a display device in front of the driver's seat of the vehicle. The in-vehicle display apparatus inclines the display unit according to the angle of the driver's line of sight.

### SUMMARY

According to an example of the present disclosure, a display device control apparatus is provided to control a display device provided on an instrument panel of a vehicle. The display device control apparatus acquires a state of the vehicle, and sets an inclination of a display screen unit included in the display device according to the state of the vehicle.

### BRIEF DESCRIPTION OF DRAWINGS

The objects, features, and advantages of the present disclosure will become more apparent from the following detailed description made with reference to the accompanying drawings. In the drawings:

FIG. 1 is a block diagram showing a configuration of a display device control apparatus according to a first embodiment;

FIG. 2 is a block diagram showing a functional configuration of the display device control apparatus according to the first embodiment;

FIG. 3 is a flowchart showing a process executed by the display device control apparatus;

FIG. 4 is an explanatory diagram showing an arrangement of a meter OLED in a passenger compartment of the vehicle;

FIG. 5 is an explanatory diagram showing a change in the inclination of a meter OLED;

FIG. 6 is an explanatory diagram showing an angle T;

FIG. 7 is a block diagram showing a configuration of a display device control apparatus according to a second embodiment;

FIG. 8 is a block diagram showing a functional configuration of a display device control apparatus according to the second embodiment;

FIG. 9 is an explanatory diagram showing a meter OLED when the state of the vehicle is a manual driving mode;

FIG. 10 is a flowchart showing a collision process executed by the display device control apparatus; and

FIG. 11 is a flowchart showing an angle change process executed by the display device control apparatus.

### DETAILED DESCRIPTION

Exemplary embodiments of the present disclosure will be described with reference to the drawings.

### First Embodiment

1. Configuration of Display Device Control Apparatus 1

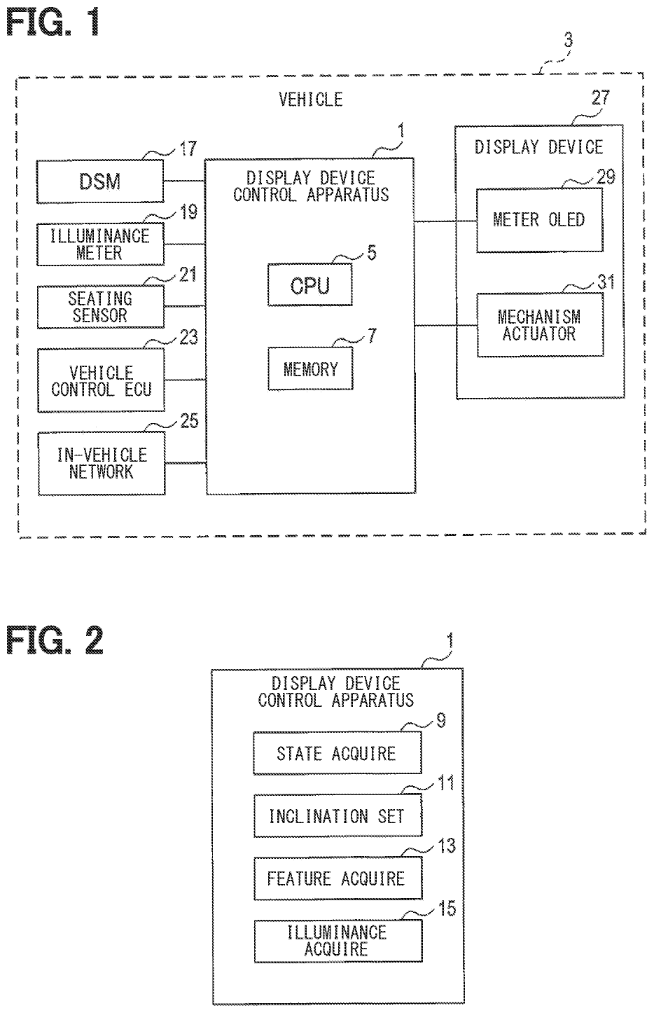

The configuration of a display device control apparatus 1 will be described with reference to FIGS. 1, 2, and 4 to 6. As shown in FIG. 1, the display device control apparatus 1 is mounted on a vehicle 3. The display device control apparatus 1 includes a microcomputer having a CPU 5 and a semiconductor memory (hereinafter referred to as a memory 7) such as a RAM and a ROM.

Each function of the display device control apparatus 1 is realized by the CPU 5 executing a program stored in a non-transitory tangible storage medium. In this embodiment, the memory 7 corresponds to the non-transitory tangible storage medium in which programs are stored. Further, by executing the program, a method corresponding to the program is executed. The display device control apparatus 1 may include one microcomputer or a plurality of microcomputers.

As shown in FIG. 2, the display device control apparatus 1 includes a state acquisition unit 9, an inclination setting unit 11, a feature acquisition unit 13, and an illuminance acquisition unit 15.

The display device control apparatus 1 is connected to a plurality of devices or components included in the vehicle 3. Such a plurality of devices or components include a DSM 17 (driver status monitor 17), an illuminance meter 19, a seating sensor 21, a vehicle control ECU 23, an in-vehicle network 25, and a display device 27, as shown in FIG. 1.

The DSM 17 photographs the face of the driver of the vehicle 3 and generates an image. The DSM 17 generates DSM information including an image of the driver's face and outputs it to the display device control apparatus 1.

The illuminance meter 19 is a sensor that measures the illuminance of outside light. The outside light is the light outside the vehicle 3. The illuminance meter 19 outputs information representing the illuminance of outside light (hereinafter referred to as illuminance information) to the display device control apparatus 1.

The seating sensor 21 is a sensor that detects whether or not the driver is seated in the driver's seat of the vehicle 3. The seating sensor 21 outputs information indicating whether or not the driver is seated in the driver's seat of the vehicle 3 (hereinafter referred to as seating information) to the display device control apparatus 1.

The vehicle control ECU 23 controls the driving operation of the vehicle 3. The vehicle 3 can set an automatic driving mode, a manual driving mode, and a parking mode. In the automatic driving mode, the vehicle 3 automatically drives. In the manual driving mode, the driver can manually drive the vehicle 3. In the parking mode, the vehicle 3 is parked.

The automatic driving mode, the manual driving mode, and the parking mode each correspond to the state of the vehicle. The automatic driving mode and the manual driving mode correspond to a traveling state of the vehicle.

The vehicle control ECU 23 outputs driving mode information in the display device control apparatus 1. The driving mode information represents which of the automatic driving mode, the manual driving mode, and the parking mode the state of the vehicle 3 at the present time is.

The in-vehicle network 25 outputs a signal representing the vehicle speed and shift value of the vehicle 3 to the display device control apparatus 1.

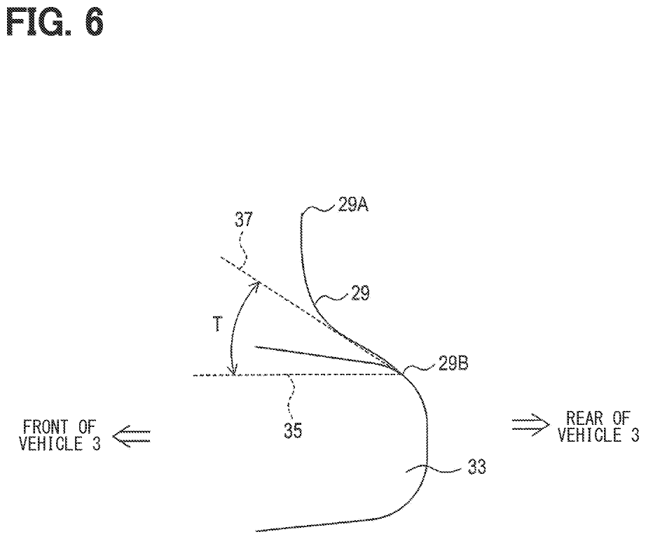

The display device 27 includes a meter OLED 29 (Organic Light Emitting Diode 29) and a movable mechanism actuator 31. The meter OLED 29 corresponds to a display unit or a display screen unit. As shown in FIGS. 5 and 6, the meter OLED 29 has a plate-shaped basic form. The meter OLED 29 is partially formed of a curved surface. The meter OLED 29 can display an image on a surface on the side facing the driver's seat of the vehicle 3. The meter OLED 29 displays an image based on the image output sent from the display device control apparatus 1. The meter OLED 29 has a function as a meter, for example. The meter OLED 29 displays, for example, visual assistance information, private information for drivers, and the like.

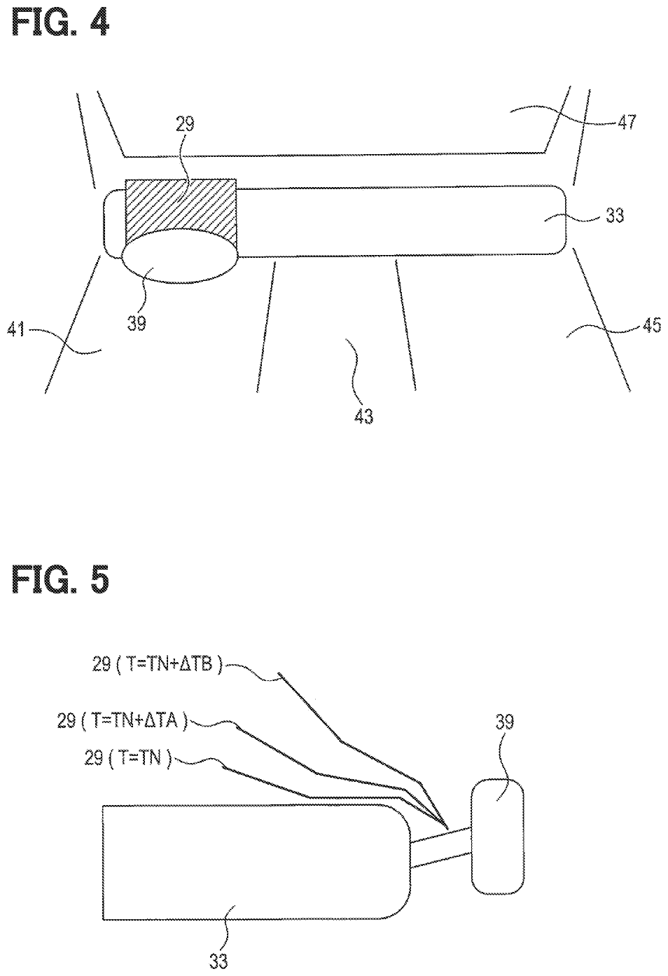

As shown in FIGS. 4 and 5, the meter OLED 29 is provided on the instrument panel 33. In FIGS. 4 and 5, 39 indicates a steering wheel. In FIG. 4, 41 indicates a driver's seat. In FIG. 4, 43 shows an armrest. In FIG. 4, 45 indicates a passenger seat. In FIG. 4, 47 shows a windshield.

As shown in FIGS. 5 and 6, the meter OLED 29 is inclined such that the front end side 29A is higher than the rear end side 29B. The front end side 29A signifies, of the meter OLED 29, the side closer to the front end of the vehicle 3, and corresponds to the upper end side of the meter OLED 29. In contrast, the rear end side 29B signifies, of the meter OLED 29, the side closer to the rear end of the vehicle 3, and corresponds to the lower end side of the meter OLED 29. The position of the rear end side 29B is fixed.

As shown in FIG. 6, when viewed from the lateral direction of the vehicle 3, an angle T is defined as an angle formed by (i) the reference surface 35 fixed to the vehicle 3 and (ii) the reference surface 37 fixed to the meter OLED 29. The angle T is a numerical value representing the inclination of the meter OLED 29 from the horizontal line. In other words, the larger the angle T, the larger the inclination of the meter OLED 29 so that the front end side 29A becomes higher.

The movable mechanism actuator 31 can change the angle T, namely the inclination. The movable mechanism actuator 31 operates based on the movable control signal sent from the display device control apparatus 1. The driving source of the movable mechanism actuator 31 is a motor.

2. Process Executed by Display Device Control Apparatus 1

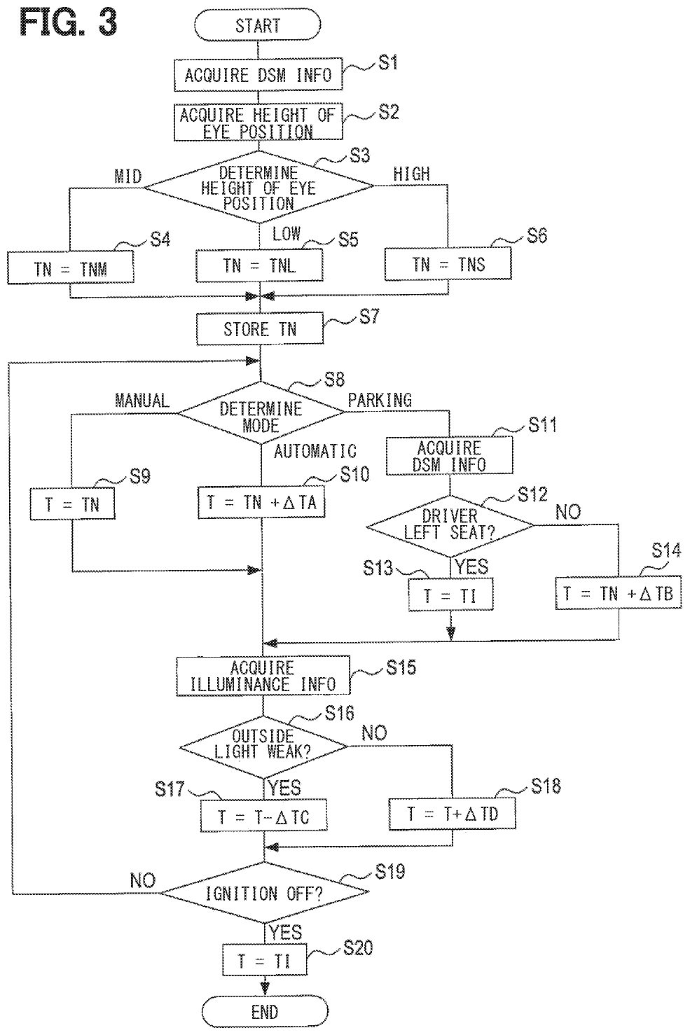

The process executed by the display device control apparatus 1 will be described with reference to FIGS. 3 and 5. The process shown in FIG. 3 is started when the ignition of the vehicle 3 is turned on. When the ignition of the vehicle 3 is off, the angle T is an initial value TI. The initial value TI is a fixed value. The display device control apparatus 1 stores the initial value TI in advance. Immediately after the ignition is turned on, the state of the vehicle 3 is the manual driving mode.

In step 1, the state acquisition unit 9 acquires DSM information using the DSM 17.

In step 2, the state acquisition unit 9 acquires the height of the driver's eye position based on the DSM information acquired in step 1. The height of the driver's eye position is the height with respect to the vehicle 3. The height of the driver's eye position corresponds to the physical feature of the driver.

In step 3, the state acquisition unit 9 determines whether the height of the driver's eye position acquired in step 2 belongs to any of the low range, the medium range, and the high range. The medium range is higher than the low range. The high range is even higher than the medium range. The display device control apparatus 1 stores the low range, the medium range, and the high range in advance.

When the height of the driver's eye position belongs to the medium range, this process proceeds to step 4. When the height of the driver's eye position belongs to the low range, this process proceeds to step 5. When the height of the driver's eye position belongs to the high range, this process proceeds to step 6.

In step 4, the inclination setting unit 11 sets the value of the reference angle TN as TNM. TNM is a fixed value greater than 0 degrees and less than 90 degrees. The display device control apparatus 1 stores the TNM in advance.

In step 5, the inclination setting unit 11 sets the value of the reference angle TN to TNL. TNL is a fixed value that is greater than TNM and less than 90 degrees. The display device control apparatus 1 stores the TNL in advance.

In step 6, the inclination setting unit 11 sets the value of the reference angle TN to TNS. TNS is a fixed value greater than 0 degrees and less than TNM. The display device control apparatus 1 stores the TNS in advance.

In step 7, the inclination setting unit 11 stores the value of the reference angle TN determined in any of steps 4 to 6.

In step 8, the inclination setting unit 11 acquires driving mode information from the vehicle control ECU 23. The inclination setting unit 11 determines which of the automatic driving mode, the manual driving mode, and the parking mode the state of the vehicle 3 at the present time is, based on the driving mode information.

When the present state of the vehicle 3 is the manual driving mode, this process proceeds to step 9. When the state of the vehicle 3 at the present time is the automatic driving mode, this process proceeds to step 10. When the present state of the vehicle 3 is the parking mode, this process proceeds to step 11.

In step 9, the inclination setting unit 11 sets the angle T to the reference angle TN stored in step 7 by using the movable mechanism actuator 31. As a result, the angle T becomes the reference angle TN. As shown in FIG. 5, when the angle T is the reference angle TN, the front end side 29A is low and the inclination of the meter OLED 29 is small.

In step 10, the inclination setting unit 11 sets the angle T to TN+ΔTA using the movable mechanism actuator 31. As a result, the angle T becomes TN+ΔTA. TN+ΔTA is a value obtained by adding ΔTA to the reference angle TN stored in step 7. ΔTA is a positive fixed value. TN+ΔTA is larger than the reference angle TN stored in step 7.

As shown in FIG. 5, when the angle T is TN+ΔTA, the inclination of the meter OLED 29 is larger than that when the angle T is the reference angle TN, so that the front end 29A becomes higher than that when the angle T is the reference angle TN.

When the state of the vehicle 3 changes from the automatic driving mode to the manual driving mode, the angle T changes from TN+ΔTA to the reference angle TN. The speed of change of the angle T at this time is defined as a first speed. When the state of the vehicle 3 changes from the manual driving mode to the automatic driving mode, the angle T changes from the reference angle TN to TN+ΔTA. The speed of change of the angle T at this time is defined as a second speed.

The first speed is greater than the second speed. As a result, when the automatic driving mode is changed to the manual driving mode, the angle T decreases promptly and the front field of view expands promptly.

In step 11, the inclination setting unit 11 acquires the DSM information using the DSM 17.

In step 12, the inclination setting unit 11 determines whether or not the driver has left the driver's seat based on the DSM information acquired in step 11. When it is determined that the driver has left the driver's seat, this process proceeds to step 13. When it is determined that the driver has not left the driver's seat, this process proceeds to step 14.

The seating information may be used instead of the DSM information or in addition to the DSM information to determine whether or not the driver has left the driver's seat.

In step 13, the inclination setting unit 11 sets the angle T to the initial value TI by using the movable mechanism actuator 31. As a result, the angle T becomes the initial value TI. The initial value TI is, for example, a value similar to TNM.

In step 14, the inclination setting unit 11 sets the angle T to TN+ΔTB by using the movable mechanism actuator 31. As a result, the angle T becomes TN+ΔTB. TN+ΔTB is a value obtained by adding ΔTB to the reference angle TN stored in step 7. ΔTB is a positive fixed value greater than ΔTA. TN+ΔTB is larger than the reference angle TN stored in step 7 and larger than TN+ΔTA.

As shown in FIG. 5, when the angle T is TN+ΔTB, the inclination of the meter OLED 29 is larger than that when the angle T is the reference angle TN or that when the angle T is TN+ΔTA, so that the front end side 29A is higher than that when the angle T is the reference angle TN or that when the angle T is TN+ΔTA.

In step 15, the illuminance acquisition unit 15 acquires the illuminance information using the illuminance meter 19.

In step 16, the illuminance acquisition unit 15 determines whether or not the outside light is weak based on the illuminance information acquired in step 15. The weak outside light means that the illuminance of the outside light is equal to or less than a preset threshold value. When it is determined that the outside light is weak, this process proceeds to step 17. When it is determined that the outside light is strong, this process proceeds to step 18.

In step 17, the inclination setting unit 11 uses the movable mechanism actuator 31 to make the angle T smaller than the present angle T by ΔTC. ΔTC is a positive fixed value.

In step 18, the inclination setting unit 11 uses the movable mechanism actuator 31 to increase the angle T larger than the present angle T by ΔTD. ΔTD is a positive fixed value.

In step 19, the state acquisition unit 9 determines whether or not the ignition of the vehicle 3 is turned off. When the ignition is turned off, the process proceeds to step 20. When the ignition remains on, the process proceeds to step 8.

In step 20, the inclination setting unit 11 sets the angle T to the initial value TI by using the movable mechanism actuator 31. As a result, the angle T becomes the initial value TI.

3. Effect Provided by Display Device Control Apparatus 1

(1A) The display device control apparatus 1 can set the inclination of the meter OLED 29 according to the state of the vehicle 3. Therefore, the display device control apparatus 1 can make the inclination of the meter OLED 29 suitable according to the state of the vehicle 3.

(1B) When the state of the vehicle 3 is in the automatic driving mode, the display device control apparatus 1 increases the inclination of the meter OLED 29 so that the front end side 29A is higher than that when the state of the vehicle 3 is in the manual driving mode.

When the state of the vehicle 3 is the automatic driving mode, the operating status of the automatic driving function or the like may be displayed on the meter OLED 29. Therefore, when the state of the vehicle 3 is the automatic driving mode, the amount of information displayed on the meter OLED 29 is larger than that in the manual driving mode.

The display device control apparatus 1 increases the inclination of the meter OLED 29 to enable the front end side 29A to become higher when the state of the vehicle 3 is the automatic driving mode. Therefore, the driver can easily visually recognize a large amount of information displayed on the meter OLED 29.

When the state of the vehicle 3 is the manual driving mode, it is necessary to widen the field of view ahead. When the state of the vehicle 3 is the manual driving mode, the display device control apparatus 1 reduces the inclination of the meter OLED 29 so that the front end side 29A is lowered, and thus the front field of view is widened.

(1C) In the display device control apparatus 1, when the state of the vehicle 3 is the parking mode and the driver is not away from the seat, the inclination of the meter OLED 29 is larger than that when the vehicle 3 is in the manual driving mode or the automatic driving mode so that the front end side 29A is higher than that when the vehicle 3 is in the manual driving mode or the automatic driving mode. The driver can thereby easily visually recognize the display content of the meter OLED 29 even when the seat is reclining while parking.

(1D) The display device control apparatus 1 sets the inclination of the meter OLED 29 according to the physical feature of the driver. Therefore, the display device control apparatus 1 can make the inclination of the meter OLED 29 suitable according to the physical feature of the driver.

(1E) In the display device control apparatus 1, the lower the position of the driver's eyes, the greater the inclination of the meter OLED 29 so that the front end side 29A becomes higher. Therefore, it is possible to suppress the influence of the height of the driver's eye position on the visibility of the meter OLED 29.

(1F) The display device control apparatus 1 sets the inclination of the meter OLED 29 according to the illuminance of the outside light. Therefore, the display device control apparatus 1 can make the inclination of the meter OLED 29 suitable according to the illuminance of the outside light.

(1G) The display device control apparatus 1 increases the inclination of the meter OLED 29 so that the front end side 29A becomes higher as the illuminance of the outside light increases. Therefore, the display device control apparatus 1 can prevent the visibility of the meter OLED 29 from being lowered due to the outside light.

(1H) The display device control apparatus 1 sets the angle T to the initial value TI when the driver leaves the seat. Therefore, it is possible to suppress heat accumulation inside the instrument panel 33 due to direct sunlight entering the inside of the instrument panel 33.

### Second Embodiment

1. Differences from First Embodiment

Since the basic configuration of a second embodiment is the same as that of the first embodiment, the differences will be described below. The same reference signs as those in the first embodiment indicate the same configurations, and the preceding description will be referred to.

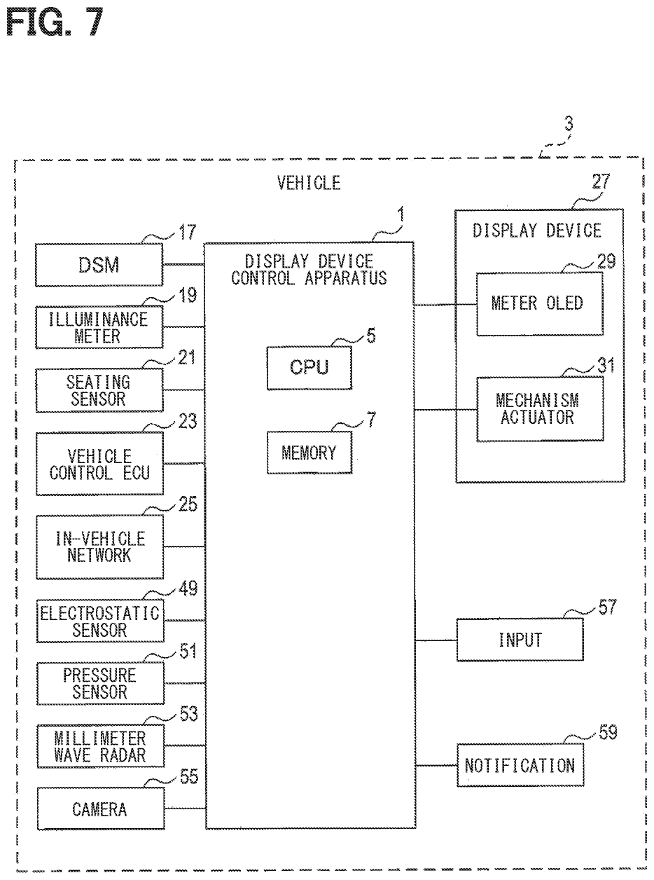

As shown in FIG. 7, the display device control apparatus 1 is connected to an electrostatic sensor 49, a pressure sensor 51, a millimeter wave radar 53, a camera 55, an input device 57, and a notification device 59, in addition to the devices or components in the first embodiment.

The electrostatic sensor 49 is provided on a steering wheel 39. The electrostatic sensor 49 detects that the driver is gripping the steering wheel 39 based on the change in capacitance. The electrostatic sensor 49 is provided on each of the portions of the steering wheel 39 that are gripped by the right hand and the left hand, respectively. Therefore, the electrostatic sensor 49 can detect that the driver is gripping the steering wheel 39 with both hands. The electrostatic sensor 49 sends the detection result to the display device control apparatus 1.

The pressure sensor 51 is provided on the steering wheel 39. The pressure sensor 51 detects that the driver is gripping the steering wheel 39 based on the change in pressure. The pressure sensor 51 is provided in each of the portions of the steering wheel 39 that are gripped by the right hand and the left hand, respectively. Therefore, the pressure sensor 51 can detect that the driver is gripping the steering wheel 39 with both hands. The pressure sensor 51 sends the detection result to the display device control apparatus 1.

The millimeter wave radar 53 and the camera 55 each detect an object target existing around the vehicle 3. Examples of the object target include other vehicles, pedestrians, fixed objects, and the like. The millimeter wave radar 53 and the camera 55 each send information about the detected object target (hereinafter referred to as peripheral information) to the display device control apparatus 1. Peripheral information includes, for example, information indicating the position of an object target existing around the vehicle 3, the speed of the object target, the distance from the vehicle 3 to the object target, and the type of the object target.

The input device 57 is provided in the passenger compartment of the vehicle 3. The input device 57 accepts input by the driver. The contents of the input include an instruction to restart the operation, which will be described later.

The notification device 59 is provided in the passenger compartment of the vehicle 3. The notification device 59 notifies the driver by speech, image, vibration, or the like.

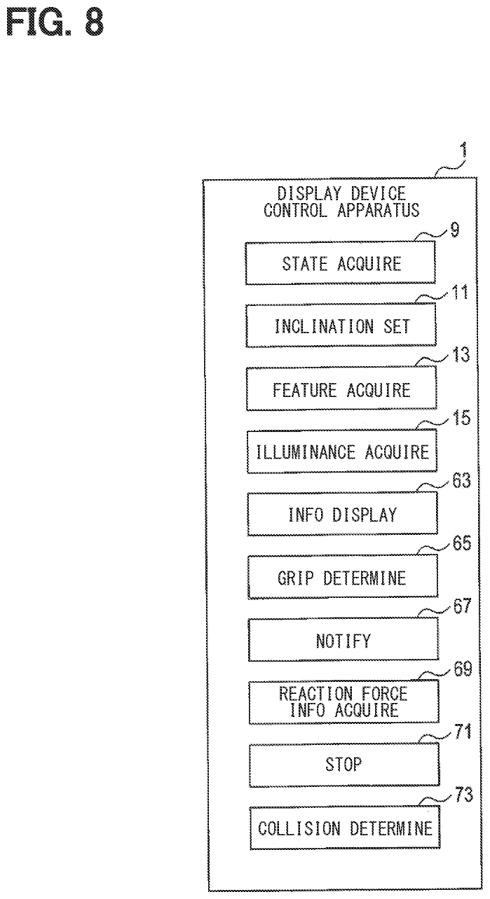

As shown in FIG. 8, in addition to the configuration in the first embodiment, the display device control apparatus 1 includes an information display unit 63, a grip determination unit 65, a notification unit 67, a reaction force information acquisition unit 69, a stop unit 71, and a collision determination unit 73.

The movable mechanism actuator 31 sends the motor reaction force information to the display device control apparatus 1. The motor reaction force information is information indicating the magnitude of the reaction force applied to the motor of the movable mechanism actuator 31. The reaction force is a force in the direction opposite to the rotation direction of the motor. For example, suppose a case where the movable mechanism actuator 31 is trying to change the angle T, the driver's finger or an object comes into contact with the meter OLED 29 and hinders the movement of the meter OLED 29. In such a case, the reaction force becomes large. The driver's finger or object in contact with the meter OLED 29 may be sandwiched between the instrument panel 33 or the center console and the meter OLED 29, for example.

2. Process to Display Information on Meter OLED 29 During Manual Driving Mode

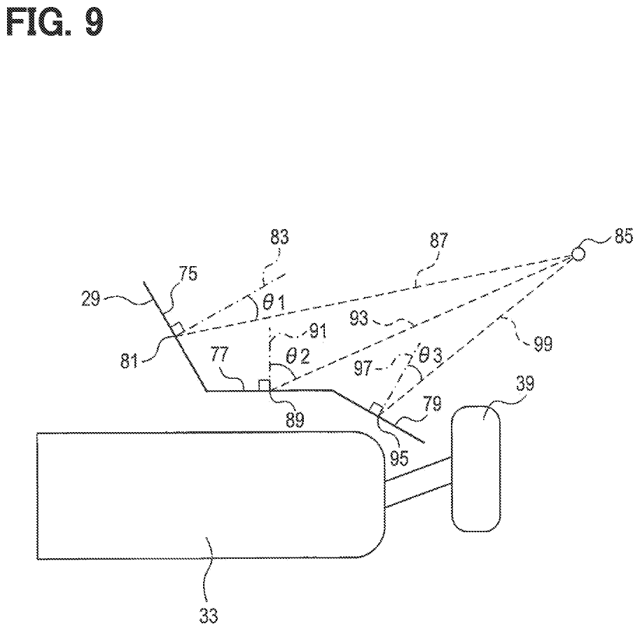

As shown in FIG. 9, the meter OLED 29 includes a first part 75, a second part 77, and a third part 79. The surfaces of the first part 75, the second part 77, and the third part 79 are flat surfaces, respectively. The second part 77 is adjacent to the first part 75 and is bent with respect to the first part 75. The third part 79 is adjacent to the second part 77 and is bent with respect to the second part 77.

Let 81 be the center of the first part 75. Let 83 be a normal that passes through the center 81 and is orthogonal to the first part 75. The angle formed by (i) the line-of-sight direction 87 from the driver's viewpoint 85 toward the center 81 and (ii) the normal line 83 is defined as the incident angle 81.

Let 89 be a center of the second part 77. Let 91 be a normal that passes through the center 89 and is orthogonal to the second part 77. The angle formed by (i) the line-of-sight direction 93 from the driver's viewpoint 85 toward the center 89 and (ii) the normal line 91 is defined as the incident angle 82.

Let 95 be the center of the third part 79. Let 97 be the normal that passes through the center 95 and is orthogonal to the third part 79. The angle formed by (i) the line-of-sight direction 99 from the driver's viewpoint 85 toward the center 95 and (ii) the normal line 97 is defined as the incident angle 83.

When the state of the vehicle 3 is in the manual driving mode, the angle T is smaller than that when the state of the vehicle 3 is in the automatic driving mode. When the state of the vehicle 3 is the manual driving mode, the incident angle 81 is smaller than each of the incident angle 82 and the incident angle 83. That is, when the state of the vehicle 3 is the manual driving mode, the first part 75 is a part of the meter OLED 29 where the incident angle of the line-of-sight of the driver is minimized.

When the state of the vehicle 3 is the manual driving mode, the information display unit 63 displays information indicating the traveling state of the vehicle 3 or the operating state of the function of the vehicle 3 in the first part 75. Examples of the traveling state of the vehicle 3 include the vehicle speed, the remaining amount of fuel, and the like. Examples of the operating state of the function of the vehicle 3 include the setting contents of ACC (adaptive cruise control), whether or not ACC is on, and the like.

3. Collision Process

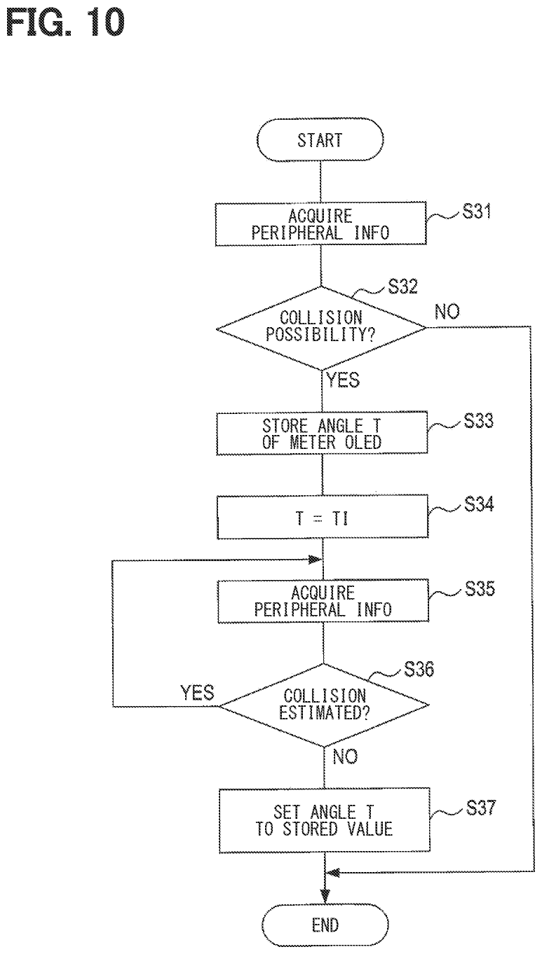

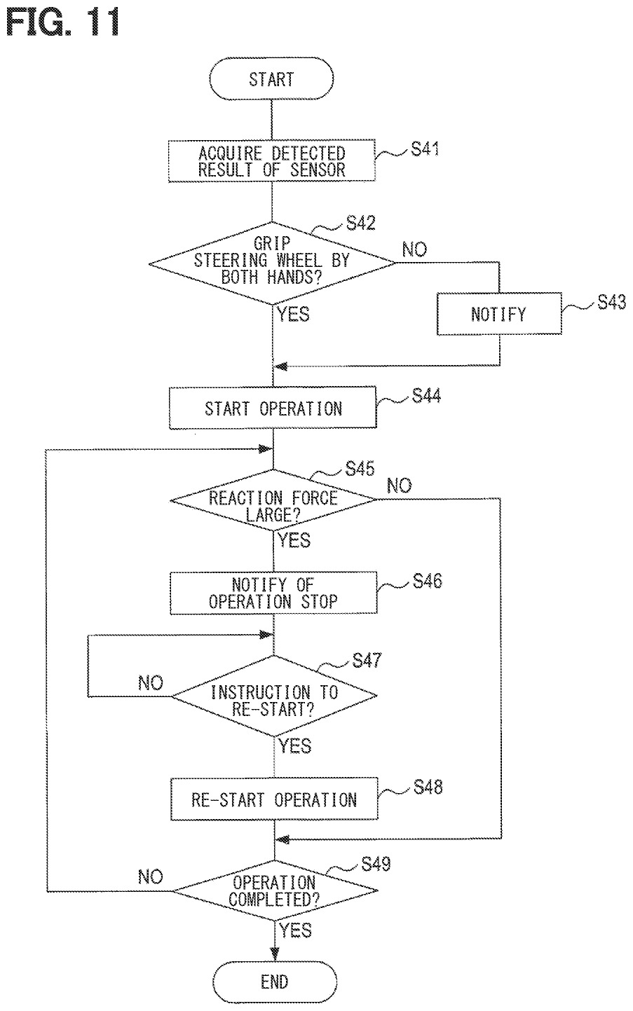

The display device control apparatus 1 executes a process of changing the angle T of the meter OLED 29 according to the risk of collision (hereinafter, the above process is referred to as a collision process). The display device control apparatus 1 repeatedly executes the collision process at predetermined time intervals while the vehicle 3 is traveling. The collision process will be described with reference to FIG. 10.

In step 31, the collision determination unit 73 acquires peripheral information using the millimeter wave radar 53 and the camera 55.

In step 32, the collision determination unit 73 determines whether or not the vehicle 3 is expected to collide with another object target based on the peripheral information acquired in step 31. When the vehicle 3 is expected to collide with another object target, the process proceeds to step 33. When the vehicle 3 is unexpected to collide with another object target, this process ends.

In step 33, the inclination setting unit 11 stores the present angle T of the meter OLED 29.

In step 34, the inclination setting unit 11 sets the angle T to the initial value TI by using the movable mechanism actuator 31. As a result, the angle T becomes the initial value TI.

In step 35, the collision determination unit 73 acquires peripheral information using the millimeter wave radar 53 and the camera 55.

In step 36, the collision determination unit 73 determines whether or not the vehicle 3 is expected to collide with another object target based on the peripheral information acquired in step 35. When the vehicle 3 is expected to collide with another object target, the process proceeds to step 35. When the vehicle 3 is unexpected to collide with another object target, this process proceeds to step 37.

In step 37, the inclination setting unit 11 uses the movable mechanism actuator 31 to set the angle T to the value stored in the immediately preceding step 33. As a result, the angle T becomes a value stored in the step 33 immediately before.

4. Process when Angle T Changes

When the angle T changes, the inclination setting unit 11, the grip determination unit 65, the notification unit 67, the reaction force information acquisition unit 69, and the stop unit 71 execute the following process (hereinafter referred to as angle change process).

As the angle T changes, there are cases where the angle T becomes smaller and cases where the angle T becomes larger. When the angle T changes, the processes of steps 9, 10, 13, 14, 17, 18, 34, and 37 may be executed. The process at the time of angle change will be described with reference to FIG. 11.

In step 41, the grip determination unit 65 acquires the detection results of the electrostatic sensor 49 and the pressure sensor 51.

In step 42, the gripping determination unit 65 determines whether or not the driver is gripping the steering wheel 39 with both hands based on the detection result acquired in step 41. When it is determined that the driver is gripping the steering wheel 39 with both hands, this process proceeds to step 44. When it is determined that the driver is not gripping the steering wheel 39 with both hands, this process proceeds to step 43.

In step 43, the notification unit 67 uses the meter OLED 29 to display a warning. The warning corresponds to a notification when the driver is not gripping the steering wheel 39 with both hands.

In step 44, the inclination setting unit 11 starts operation using the movable mechanism actuator 31. The operation is to change the angle T of the meter OLED 29 to a target value.

In step 45, the reaction force information acquisition unit 69 acquires the motor reaction force information from the movable mechanism actuator 31. The stop unit 71 determines whether or not the reaction force represented by the motor reaction force information is larger than a preset threshold value. When the reaction force is greater than the threshold value, the process proceeds to step 46. When the reaction force is less than the threshold value, the process proceeds to step 49.

In step 46, the inclination setting unit 11 stops operating. In addition, the notification unit 67 displays a notification using the meter OLED 29. The notification indicates that the operation cannot be performed normally.

In step 47, the stop unit 71 determines whether or not the operation restart instruction has been input to the input device 57. The driver can see the notification displayed in step 46, eliminate the factors that have hindered the operation, and then input the operation restart instruction to the input device 57. As a factor that hinders the operation, for example, the driver's finger, the driver's head, an object, or the like are in contact with the meter OLED 29. When the instruction to restart the operation is input to the input device 57, this process proceeds to step 48. When no instruction to restart the operation is input to the input device 57, this process returns to the previous step 47.

In step 48, the inclination setting unit 11 re-starts operation using the movable mechanism actuator 31.

In step 49, the inclination setting unit 11 determines whether or not the operation is completed. When the operation is completed, the angle T becomes the target value. When the operation is completed, this process is ended. When the operation is not completed, this process proceeds to step 45.

5. Effect Provided by Display Device Control Apparatus 1

According to the second embodiment described in detail above, the effects of the above-mentioned first embodiment are obtained, and the following effects are further obtained.

(2A) When the state of the vehicle 3 is the manual driving mode, the display device control apparatus 1 displays information indicating the traveling state of the vehicle 3 or the operating state of the function of the vehicle 3 in the first part 75. The first part 75 is a part of the meter OLED 29 where the incident angle of the driver's line-of-sight is minimized when the vehicle 3 is in the manual driving mode. That is, the first part 75 is the part of the meter OLED 29 of which the display is most easily recognized by the driver when the state of the vehicle 3 is the manual driving mode.

The information representing the running state of the vehicle 3 or the operating state of the function of the vehicle 3 is information necessary for manual driving. Therefore, when the state of the vehicle 3 is the manual driving mode, the display device control apparatus 1 can display the information necessary for the manual driving in an easy-to-see manner for the driver.

(2B) When the inclination of the meter OLED 29 changes and the driver is not gripping the steering wheel 39 with both hands, the driver's finger may be caught between (i) the meter OLED 29 and (ii) the instrument panel 33, the center console, or the like. The display device control apparatus 1 determines whether or not the driver is gripping the steering wheel 39 with both hands when the inclination of the meter OLED 29 changes. When the display device control apparatus 1 determines that the driver is not gripping the steering wheel 39 with both hands, the display device control apparatus 1 notifies the driver. Therefore, the display device control apparatus 1 can prevent the driver's finger from being pinched between (i) the meter OLED 29 and (ii) the instrument panel 33, the center console, or the like.

(2C) When the inclination of the meter OLED 29 changes, a driver's finger or an object may be caught between (i) the meter OLED 29 and (ii) the instrument panel 33, the center console, or the like. In this case, when the inclination of the meter OLED 29 continues to change, a problem may occur. The display device control apparatus 1 acquires the magnitude of the reaction force applied to the motor when the inclination of the meter OLED 29 changes. When the magnitude of the reaction force is larger than the preset threshold value, the display device control apparatus 1 stops the change in the inclination of the meter OLED 29. The change in the inclination of the meter OLED 29 remains stopped until the driver inputs an instruction to resume operation to the input device 57.

Therefore, the display device control apparatus 1 can stop the change in the inclination of the meter OLED 29 when the driver's finger or an object is caught between (i) the meter OLED 29 and (ii) the instrument panel 33, the center console, or the like.

(2D) The display device control apparatus 1 determines whether or not the vehicle 3 is expected to collide with another object target. When the display device control apparatus 1 determines that the vehicle 3 is expected to collide with another target, the display device control apparatus 1 decreases the inclination of the meter OLED 29 so that the front end side 29A is lower than that when it is determined that the vehicle is unexpected to collide. Therefore, the display device control apparatus 1 can prevent the meter OLED 29 from being damaged when the vehicle 3 collides with another object target. Further, the display device control apparatus 1 can prevent the fragments from scattering in the direction of the driver even if the meter OLED 29 is damaged.

### Other Embodiments

Although embodiments of the present disclosure have been described above, the present disclosure is not limited to the above-described embodiments, and it is possible to implement various modifications.

(1) When the angle T is large, the meter OLED 29 may make it difficult to see other display devices. As another display device, for example, there is a display device on the center console side. When the other display device is difficult to see, the display device control apparatus 1 can adjust the display contents of the other display device. For example, the display device control apparatus 1 can adjust so as not to display any information on a part of other display devices that is difficult to see due to the meter OLED 29.

(2) Another display device may be used instead of the meter OLED 29. Examples of other display devices include liquid crystal displays and the like. The form of the meter OLED 29 may be a flat shape.

(3) In the first embodiment and the second embodiment, when the ignition is turned on, the processes of steps 1 to 7 are performed. The display device control apparatus 1 may perform the processes of steps 1 to 7 when, for example, requested by the driver. The request from the driver is, for example, a switch operation by the driver, a gesture of the driver, a speech uttered by the driver, or the like.

(4) The reference angle TN may be constant regardless of the physical feature of the driver.

(5) The process of step 8 may be omitted. In this case, the angle T is the reference angle TN stored in step 7 regardless of the state of the vehicle 3.

(6) The processes of steps 15 and 16 may be omitted. In this case, the angle T is a value set in the processes of steps 9 to 14 regardless of the illuminance of the outside light.

(7) There are, for example, a plurality of levels in the state of automatic driving. As the state of automatic driving, for example, there are level 1, level 2, and level 3. In the level 1 state, the vehicle 3 automatically travels in the traveling lane by the traveling safety function such as ACC or LKA. In the level 1 state, the driver needs to grip the steering wheel 39.

In the level 2 state, there is no need for the driver to operate the steering wheel. In the level 2 state, the driver needs to check the periphery of the vehicle 3. In the level 3 state, the driver is not obliged to check the periphery of the vehicle 3.

In step 8, for example, when it is determined that the driving mode is automatic driving, the level of automatic driving may be further determined, and the processing may be changed according to the level of automatic driving. For example, when it is determined in step 8 that the level of automatic driving is level 1 or level 2, the process can proceed to step 10.

In step 10, since the angle T is TN+ΔTA, the driver can check the periphery of the vehicle 3. Further, the display area of the meter OLED 29 becomes larger than that when the angle T is TN.

Further, for example, when it is determined in step 8 that the level of automatic driving is level 3, the process can proceed to step 14. In step 14, since the angle T is TN+ΔTB, the display area of the meter OLED 29 is further increased. When the level of automatic driving is level 3, the driver is not obliged to check the periphery of the vehicle 3, so even if the meter OLED 29 limits the driver's field of view, a problem is unlikely to occur.

(8) The display device control apparatus 1 and method thereof described in the above embodiments in the present disclosure may be implemented by one or more than one special-purpose computer, which may be created by configuring (a) a memory and a processor programmed to execute one or more particular functions embodied in computer programs. Alternatively, the display device control apparatus 1 and methods thereof described in the above embodiments in the present disclosure may be implemented by one or more than one special purpose computer, which may be created by configuring (b) a processor provided by one or more special purpose hardware logic circuits. Yet alternatively, the display device control apparatus 1 and methods described in the above embodiments in the present disclosure may be implemented by one or more than one special purpose computer, which may be created by configuring a combination of (a) a memory and a processor programmed to execute one or more particular functions embodied in computer programs and (b) a processor provided by one or more special purpose hardware logic circuits. The computer program may also be stored on a computer readable non-transitory tangible recording medium as computer executable instructions. The technique for realizing the functions of the respective units included in the display device control apparatus 1 does not necessarily need to include software, and all of the functions may be realized with the use of one or multiple hardware.

(9) Multiple functions of one configuration element in the above embodiment may be implemented by multiple configuration elements, or a single function of one configuration element may be implemented by multiple configuration elements. Further, multiple functions of multiple configuration elements may be implemented by one configuration element, or one function implemented by multiple configuration elements may be implemented by one configuration element. In addition, a part of the configuration of the above embodiment may be omitted. Further, at least part of the configuration of the above-described embodiment may be added to or replaced with the configuration of another embodiment described above.

(10) The present disclosure can be realized in various forms, in addition to the display device control apparatus described above, such as a system including the display device control apparatus as a constituent element, a program for causing a computer to function as the display device control apparatus, a non-transitory tangible storage medium such as a semiconductor memory storing the program, or a display device control method.

For reference to further explain features of the present disclosure, the description is added as follows.

There is disclosed an in-vehicle display apparatus that includes a display device in front of the driver's seat of the vehicle. The in-vehicle display apparatus inclines the display unit according to the angle of the driver's line of sight.

Detailed studies by the inventors have found the following issues. The preferable inclination of the display unit changes depending on the situation other than the angle of the driver's line of sight.

It is thus desired for the present disclosure to provide a display device control apparatus capable of setting the inclination of the display unit according to a situation.

Aspects of the present disclosure described herein are set forth in the following clauses.

According to a first aspect of the present disclosure, a display device control apparatus is provided to control a display device provided on an instrument panel of a vehicle. The display device control apparatus includes a state acquisition unit and an inclination setting unit. The state acquisition unit is configured to acquire a state of the vehicle. The inclination setting unit is configured to set an inclination of a display screen unit included in the display device according to the state of the vehicle.

The display device control apparatus according to the first aspect of the present disclosure can set the inclination of the display unit according to the state of the vehicle. Therefore, the display device control apparatus according to the first aspect of the present disclosure can make the inclination of the display unit suitable according to the state of the vehicle.

According to a second aspect of the present disclosure, a display device control apparatus is provided to control a display device provided on an instrument panel of a vehicle. The display device control apparatus includes a feature acquisition unit and an inclination setting unit. The feature acquisition unit is configured to acquire a physical feature of a driver of the vehicle. The inclination setting unit is configured to set an inclination of a display screen unit included in the display device according to the physical feature.

The display device control apparatus according to the second aspect of the present disclosure can set the inclination of the display unit according to the physical feature of the driver. Therefore, the display device control apparatus according to the second aspect of the present disclosure can make the inclination of the display unit suitable according to the physical feature of the driver.

According to a third aspect of the present disclosure, a display device control apparatus is provided to control a display device provided on an instrument panel of a vehicle. The display device control apparatus includes an illuminance acquisition unit and an inclination setting unit. The illuminance acquisition unit is configured to acquire an illuminance of an outside light. The inclination setting unit is configured to set an inclination of a display screen unit included in the display device according to the illuminance of the outside light.

The display device control apparatus according to the third aspect of the present disclosure can set the inclination of the display unit according to the illuminance of the outside light. Therefore, the display device control apparatus according to the third aspect of the present disclosure can make the inclination of the display unit suitable according to the illuminance of the outside light.

What is claimed is:

1. A display device control apparatus that controls a display device provided on an instrument panel of a vehicle, the display device control apparatus comprising:
a state acquisition unit configured to acquire a state of the vehicle; and
an inclination setting unit configured to set an inclination of a display screen unit included in the display device according to the state of the vehicle,
wherein:
the state of the vehicle includes a manual driving state and an automatic driving state; and
the inclination setting unit is further configured to set the inclination of the display screen unit such that the inclination of the display screen unit under the automatic driving state is larger than the inclination of the display screen unit under the manual driving state to cause a front end side of the display screen unit under the automatic driving state to be higher than the front end side under the manual driving state.

2. The display device control apparatus according to claim 1, further comprising:
an information display unit configured to display vehicle information on an incident angle minimum part of the display screen unit under the manual driving state,
the vehicle information being information on traveling state of the vehicle or operating state of a function of the vehicle,
the incident angle minimum part being a part where an incident angle of a line of sight of a driver of the vehicle is minimum.

3. A display device control apparatus that controls a display device provided on an instrument panel of a vehicle, the display device control apparatus comprising:
a state acquisition unit configured to acquire a state of the vehicle;
an inclination setting unit configured to set an inclination of a display screen unit included in the display device according to the state of the vehicle;
a gripping determination unit configured to determine whether or not a driver of the vehicle is gripping a steering wheel with both hands under a state where the inclination of the display screen unit changes; and
a notification unit configured to issue a notification in response to the gripping determination unit determining that the driver is not gripping the steering wheel with both hands.

4. A display device control apparatus that controls a display device provided on an instrument panel of a vehicle, the display device control apparatus comprising:
a feature acquisition unit configured to acquire a physical feature of a driver of the vehicle;
an inclination setting unit configured to set an inclination of a display screen unit included in the display device according to the physical feature;
a gripping determination unit configured to determine whether or not the driver of the vehicle is gripping a steering wheel with both hands under a state where the inclination of the display screen unit changes; and
a notification unit configured to issue a notification in response to the gripping determination unit determining that the driver is not gripping the steering wheel with both hands.

5. A display device control apparatus that controls a display device provided on an instrument panel of a vehicle, the display device control apparatus comprising:
an illuminance acquisition unit configured to acquire an illuminance of an outside light;
an inclination setting unit configured to set an inclination of a display screen unit included in the display device according to the illuminance of the outside light;
a gripping determination unit configured to determine whether or not a driver of the vehicle is gripping a steering wheel with both hands under a state where the inclination of the display screen unit changes; and
a notification unit configured to issue a notification in response to the gripping determination unit determining that the driver is not gripping the steering wheel with both hands.

6. A display device control apparatus that controls a display device provided on an instrument panel of a vehicle, the display device control apparatus comprising:
a state acquisition unit configured to acquire a state of the vehicle;
an inclination setting unit configured to set an inclination of a display screen unit included in the display device according to the state of the vehicle;
a reaction force information acquisition unit configured to acquire a magnitude of a reaction force applied to a driving source that changes the inclination of the display screen unit while the inclination of the display screen unit is changing; and
a stop unit configured to stop the inclination of the display screen unit changing in response to the magnitude of the reaction force acquired by the reaction force information acquisition unit being larger than a preset threshold value.

7. A display device control apparatus that controls a display device provided on an instrument panel of a vehicle, the display device control apparatus comprising:
a feature acquisition unit configured to acquire a physical feature of a driver of the vehicle;
an inclination setting unit configured to set an inclination of a display screen unit included in the display device according to the physical feature;
a reaction force information acquisition unit configured to acquire a magnitude of a reaction force applied to a driving source that changes the inclination of the display screen unit while the inclination of the display screen unit is changing; and
a stop unit configured to stop the inclination of the display screen unit changing in response to the magnitude of the reaction force acquired by the reaction force information acquisition unit being larger than a preset threshold value.

8. A display device control apparatus that controls a display device provided on an instrument panel of a vehicle, the display device control apparatus comprising:
an illuminance acquisition unit configured to acquire an illuminance of an outside light;
an inclination setting unit configured to set an inclination of a display screen unit included in the display device according to the illuminance of the outside light;
a reaction force information acquisition unit configured to acquire a magnitude of a reaction force applied to a driving source that changes the inclination of the display screen unit while the inclination of the display screen unit is changing; and
a stop unit configured to stop the inclination of the display screen unit changing in response to the magnitude of the reaction force acquired by the reaction force information acquisition unit being larger than a preset threshold value.

9. The display device control apparatus according to claim 1, wherein:
the state of the vehicle includes a parking state and a traveling state; and
the inclination setting unit is further configured to set the inclination of the display screen unit such that the inclination of the display screen unit under the parking state is larger than the inclination of the display screen unit under the traveling state to cause the front end side of the display screen unit under the parking state to be higher than the front end side under the traveling state.

10. The display device control apparatus according to claim 4, wherein:
the physical feature includes a height of an eye position of the driver; and as the height of the eye position of the driver increases, the inclination setting unit is further configured to increase the inclination of the display screen unit so that a front end side of the display screen unit becomes higher.

11. The control apparatus according to claim 5, wherein:
as the illuminance of the outside light increases, the inclination setting unit is further configured to increase the inclination of the display screen unit so that a front end side of the display screen unit becomes higher.

12. The control apparatus according to claim 1, further comprising:
a collision determination unit configured to determine whether a present state is a collision expected state where the vehicle is expected to collide with an object target or a collision unexpected state where the vehicle is unexpected to collide with an object target,
wherein:
the inclination setting unit is further configured to set the inclination of the display screen unit such that the inclination of the display screen unit under the collision expected state is smaller than the inclination of the display screen unit under the collision unexpected state to cause the front end side of the display screen unit under the collision expected state to be lower than the front end side under the collision unexpected state.

13. The control apparatus according to claim 1, wherein:
the display screen unit is provided such that an upper end side is more forward in a traveling direction of the vehicle than a lower end side so that the upper end side serves as the front end side and the lower end side serves as a rear end side.

14. The control apparatus according to claim 1, further comprising:
one or more memories: and
one or more processors communicably coupled with the one or more memories, the one or more processors being configured to implement the state acquisition unit, and the inclination setting unit.

15. The control apparatus according to claim 3, further comprising:
one or more memories: and
one or more processors communicably coupled with the one or more memories, the one or more processors being configured to implement the state acquisition unit, the inclination setting unit, the gripping determination unit, and the notification unit.

16. The control apparatus according to claim 4, further comprising:
one or more memories: and
one or more processors communicably coupled with the one or more memories, the one or more processors being configured to implement the feature acquisition unit, the inclination setting unit, the gripping determination unit, and the notification unit.

17. The control apparatus according to claim 5, further comprising:
one or more memories: and
one or more processors communicably coupled with the one or more memories, the one or more processors being configured to implement the illuminance acquisition unit, the inclination setting unit, the gripping determination unit, and the notification unit.

18. The control apparatus according to claim 6, further comprising:
one or more memories: and
one or more processors communicably coupled with the one or more memories, the one or more processors being configured to implement the state acquisition unit, the inclination setting unit, the reaction force information acquisition unit, and the stop unit.

19. The control apparatus according to claim 7, further comprising:
one or more memories: and
one or more processors communicably coupled with the one or more memories, the one or more processors being configured to implement the feature acquisition unit, the inclination setting unit, the reaction force information acquisition unit, and the stop unit.

20. The control apparatus according to claim 8, further comprising:
one or more memories: and
one or more processors communicably coupled with the one or more memories, the one or more processors being configured to implement the illuminance acquisition unit, the inclination setting unit, the reaction force information acquisition unit, and the stop unit.
